(19) United States
(12) Patent Application Publication
(10) Pub. No.: US 2004/0094348 A1
(43) Pub. Date: May 20, 2004

(54) Method of determining a driving mode

(75) Inventor: Zhenfu Chen, Schwalbach (DE)

Correspondence Address: Gerlinde Nattler, Continental Teves, Inc., One Continental Drive, Auburn Hills, MI, 48326, US

(73) Assignee: Continental Teves AG & Co. oHG

(21) Appl. No.: 10/636,467

(22) Filed: Aug. 7, 2003

(30) Foreign Application Priority Data
Aug. 22, 2002 (DE) 102 39 255.2

(51) Int. Cl. B60K 17/34

(52) U.S. Cl. 180/233

(57) ABSTRACT

A method determines a driving mode in a vehicle with all-wheel drive and variable coupling of the drive train between front and rear axles and with rotational speed sensors for determining the rotational behavior at the wheels.

To improve a method of determining a driving mode in a vehicle with all-wheel drive to such effect as to achieve simple and reliable determination of the driving mode without an additional sensor, two driven wheels (2WD mode) are concluded from the logical combining of the wheel speeds of the front wheels with the wheel speeds of the rear wheels and from the comparison with a threshold value, and four driven wheels (4WD mode) are concluded in dependence on the comparison result when in addition a logical combining of the left-hand and right-hand wheel speeds satisfies defined conditions.

### BACKGROUND OF THE INVENTION

The present invention relates to a method of determining a driving mode in a vehicle with all-wheel drive and variable coupling of the drive train between front and rear axles and with rotational speed sensors for determining the rotational behavior at the wheels.

In vehicles with all-wheel drive the driving mode is mostly changeable between two-wheel drive and four-wheel drive (manually and/or automatically). The driving performance of a vehicle in two-wheel drive (in 2WD mode) differs greatly from that in four-wheel drive (in 4WD mode). Different control strategies for driving dynamics control are employed in the 2WD mode and 4WD mode. In the rigid 4WD mode the driving power and the brake force are transmitted from one axle to the other axle. This renders it impossible to control the individual axles. On the other hand, the individual axles may be controlled separately in the 2WD mode. Especially on roadways with low coefficients of friction, the vehicle performance depends on the driving mode, e.g. when a vehicle is oversteering the vehicle can be stabilized in the 2WD mode by braking at the outward front wheel. In a vehicle in the 4WD mode braking at the outward front wheel is transmitted to the rear axle. The result is a large amount of brake slip and loss in cornering force at both rear wheels. This further increases the oversteering tendency of the vehicle. For the correct implementation of the control strategies, it is initially required to find out which driving mode the vehicle has assumed.

The driving mode in most vehicles with all-wheel drive is determined by means of an additional sensor (determination of the position of the switch for adjusting the driving mode or a sensor integrated in the gear unit) and relayed to the driving dynamics controller by way of wiring (hardwire) or a bus system. The following problems are encountered:

a) The signal about the driving mode is not available in some vehicles.

b) The signal about the driving mode is not reliable in some vehicles on account of sensor errors or a defective line.

c) The signal about the driving mode is physically correct, but the driving behavior of the vehicle is exactly as in the other driving mode. This happens especially frequently at low temperatures. Although the vehicle is physically in the 2WD mode and the clutch between the front axle and the rear axle should be opened, the residual torque of the clutch between the two axles due to the low temperatures is still so high that the two axles are still fixedly coupled. In this case, the vehicle acts like in the 4WD mode.

An object of the present invention is to improve upon a method of determining a driving mode in a vehicle with all-wheel drive to such end as to ensure a simple and reliable determination of the driving mode without using an additional sensor.

### SUMMARY OF THE INVENTION

This object is achieved by the present invention in that a generic method is so embodied that two driven wheels (2WD mode) are concluded from the logical combining of the wheel speeds of the front wheels with the wheel speeds of the rear wheels and the comparison with a threshold value and that four driven wheels (4WD mode) are concluded in dependence on the comparison result when in addition a logical combining of the left-hand and right-hand wheel speeds satisfies defined conditions.

Each wheel is equipped with a wheel speed sensor measuring the individual wheel's speed. To determine the driving mode at the start of the vehicle, the difference between the sum of the filtered wheel speeds of the front wheels and the sum of the filtered wheel speeds of the rear wheels is produced, and the 2WD mode is determined when the difference value exceeds the threshold value.

It is favorable that the 4WD mode is determined when the difference value does not exceed the threshold value.

It is considered advantageous as another condition for detecting the 4WD mode that the difference between the left-hand wheel speeds is produced and the 4WD mode is determined when the difference value exceeds a threshold value.

Further, it is provided as another favorable condition for detecting the 4WD mode that the difference between the right-hand wheel speeds is produced and the 4WD mode is determined when the difference value exceeds a threshold value.

The following advantages are achieved by the method of the invention for detection of the driving mode:

It is a special advantage in the method of the invention that the detection of the driving mode is based on quantities, i.e., the four measured wheel speeds, that are already available in all vehicles equipped with a driving stability system, such as ABS, TCS, ESP, and like systems. These wheel speeds measured by prior art rotational speed sensors are very important for all driving dynamics control operations and are used by the individual controllers. Therefore, the method of the invention does not necessitate additional sensors. Corresponding fail-safe strategies for the wheel speeds are also implemented in the controller and need not be developed for this reason, either. The method is easy to realize, robust and reliable. The driving mode detected by way of this method is better suited for driving dynamics control than the physical driving mode output by an additional sensor known from the art. With the present method, the driving mode can be detected and updated during travel or control operations and thus always corresponds to the driving performance of the vehicle. The method may also be used as a plausibility check for the signal about the driving mode output by the additional sensor.

In addition, it is favorable in said method that it is detected from the context of the four measured wheel speeds in which driving mode the vehicle with all-wheel drive is at present. The method observes the real driving behavior of the vehicle rather than the physical position of the switch. Certain wheel slips are necessary for detecting and updating the driving mode, said wheel slips being frequently produced when braking or starting to drive on roadways with low coefficients of friction, and where the control systems might often be employed. In addition, the method may be used as a plausibility check for the signal about the driving mode output by the additional sensor.

An embodiment of the invention is illustrated in the drawings and will be described in more detail in the following.

### BRIEF DESCRIPTION OF THE DRAWING

FIG. 1 is a schematic view of a flow chart for determining or detecting or finding out the driving mode.

### DETAILED DESCRIPTION OF THE DRAWING

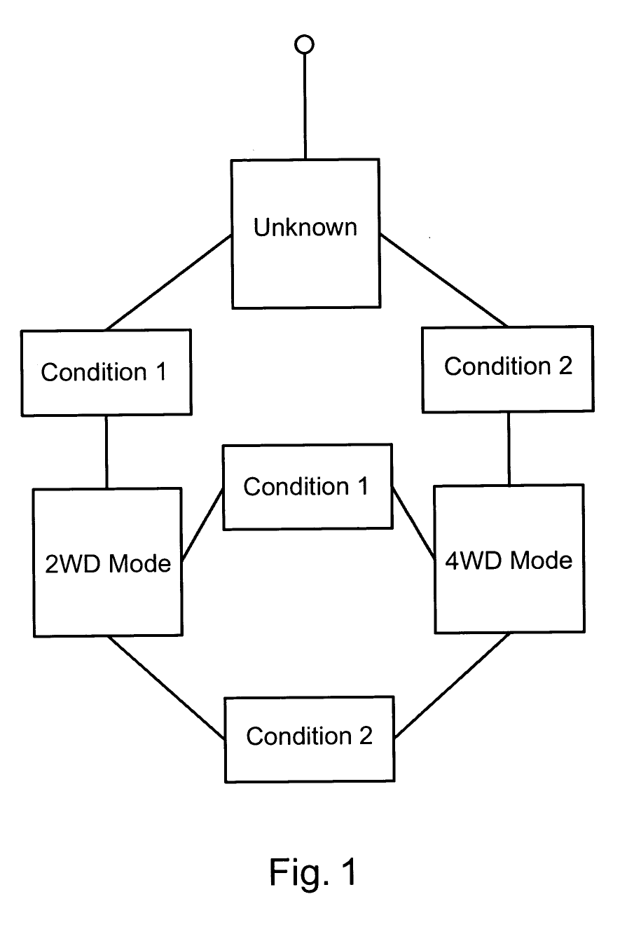

The method is based on the comparison of four individual wheel rotational speeds (ν_{fl}, νᵣₗ, νᵣₗ and νᵣₗ). For all vehicles with driving dynamics control the four rotational wheel speeds are measured by means of sensors, and the measured quantities are referred to as wheel speeds (ν_{fl}, νᵣₗ, νᵣₗ and νᵣₗ). The rotational speeds of the wheels are calculated with the following relation νᵢ=ωᵢr. In this relation, r represents the dynamic wheel radius and is constant, ωᵢ refers to the circumferential speed. In a vehicle with the rigid four-wheel driving mode the sums of the two front wheel speeds shall be equal to the sum of the two rear-wheel speeds. As each measured quantity exhibits certain errors of measurement, the measured wheel speeds are filtered by means of a low-pass filter. The filtered wheel speeds (ν_{F,fl}, ν_{F,rl}, ν_{F,rl} and ν_{F,rl}) are used to detect the driving mode. The logic is illustrated in FIG. 1. The driving mode is ‘unknown’ at the start if the following condition (condition 1) is satisfied:

a) The difference between the sum of the two filtered front-wheel speeds and the sum of the two filtered rear-wheel speeds exceeds a threshold value Δν_{Axle,thr} for N_{2WD} according to the relation

|(ν_{F,fl}+ν_{F,fr})−(ν_{F,rl}+ν_{F,rr})|>Δν_{Axle,thr} (1)

When condition 1 is satisfied, the 2WD mode is identified. In case the above-mentioned condition 1 is not satisfied but the following conditions are simultaneously satisfied for N4WD according to the relation (condition 2):

b) The difference between the sum of the two filtered front-wheel speeds and the sum of the two filtered rear-wheel speeds does not exceed the threshold value Δν_{Axle,thr}.

|(ν_{F,fl}+ν_{F,fr})−(ν_{F,rl}+ν_{F,rr})|≦Δν_{Axle,thr} (2)

c) And the difference between the two left-hand wheel speeds exceeds another threshold value Δν_{Side,thr}

|ν_{F,fl}−ν_{F,rl}|>Δν_{Side,thr} (3)

d) And the difference between the two right-hand wheel speeds also exceeds the threshold value Δν_{Side,thr}

|ν_{F,fr}−ν_{F,rr}|>Δν_{Side,thr} (4)

then the 4WD mode is identified.

After the 2WD mode is identified, the vehicle will stay in the 2WD mode until condition 2 is satisfied, then the vehicle will switch from the 2WD mode to the 4WD mode. If the 4WD mode is identified, the vehicle will stay in the 4WD mode until condition 1 is satisfied, then the vehicle will switch from the 4WD mode to the 2WD mode. During driving the current driving mode is always detected or updated with this method when the wheels exhibit certain slip values which frequently occur especially on roadways with low coefficients of friction, where a control is necessary.

Patent claims:

1. A method of determining a driving mode in a four-wheeled vehicle with all-wheel drive and variable coupling of the drive train between front and rear axles and with rotational speed sensors for determining the rotational behavior at the wheels, including the steps of:
first assuming two driven wheels (2WD mode);
logically combining the wheel speeds of the front wheels with the wheel speeds of the rear wheels;
logically combining the wheel speeds of the left-hand wheels with the wheel speeds of the right-hand wheels; and
determining four-wheel drive if the logical combinations satisfy defined conditions.

2. The method as claimed in claim 1, wherein the logical combination includes producing the difference between the sum of wheel speed values of the front wheels and the sum of wheel speed values of the rear wheels and wherein the 2WD mode is determined when the difference value exceeds a threshold value.

3. The method as claimed in claim 2, wherein the wheel speed values are filtered wheel speeds.

4. The method as claimed in any one of claim 2, wherein the 4WD mode is determined when the difference value does not exceed the threshold value.

5. The method as claimed in claim 1, wherein the difference between left-hand wheel speed values is produced and one condition for the 4WD mode is fulfilled when the difference value exceeds a threshold value.

6. The method as claimed in claim 1, wherein the difference between right-hand wheel speed values is produced and one condition for the 4WD mode is fulfilled when the difference value exceeds a threshold value.
